(19) United States
(12) Patent Application Publication
(10) Pub. No.: US 2025/0315509 A1
(43) Pub. Date: Oct. 9, 2025

(54) SYSTEMS AND METHODS FOR AUTOMATED SOFTWARE DEVELOPMENT GOVERNANCE

(71) Applicant: The PNC Financial Services Group, Inc., Pittsburgh, PA (US)

(72) Inventors: Brian WARGO, Washington, PA (US); Jerold XING, Richmond Hill (CA)

(73) Assignee: The PNC Financial Services Group, Inc., Pittsburgh, PA (US)

(21) Appl. No.: 18/941,215

(22) Filed: Nov. 8, 2024

Related U.S. Application Data
(60) Provisional application No. 63/574,895, filed on Apr. 4, 2024.

(51) Int. Cl. G06F 21/12; H04L 9/40

(52) U.S. Cl. CPC G06F 21/121; H04L 63/20

(57) ABSTRACT

The disclosed embodiments describe systems and methods for providing an automated governance platform for software development. A user selection of a policy of a plurality may be received. The policy may be comprised of policy code provided by a user during the software development. A user selection of current version or a previous version of the selected policy may be selected. The policy code may be compared to the code provided by the user. Based on the comparison, an outcome may be determined. The outcome may be comprised of a plurality of respective outcomes corresponding to each of the plurality of policy requirements. Each of the plurality of respective outcomes may be indicative of whether each corresponding policy requirement is satisfied, not satisfied, not required, or unavailable. The outcome of the application may be provided. The outcome may restrict or permit the change to the code.

### CROSS-REFERENCE TO RELATED APPLICATIONS

The present application claims the benefit of priority of U.S. Provisional Application No. 63/574,895, filed Apr. 4, 2024, the entire contents of which are incorporated herein.

### TECHNICAL FIELD

The present disclosure generally relates to the field of technology platform changes. More specifically, the present disclosure relates to providing automated governance systems to manage software development.

### BACKGROUND

In modern software development, organizations are increasingly challenged by the need to manage numerous application components across a highly complex and fast-evolving software development lifecycle. Software changes in the development lifecycle often encounter issues such as version conflicts or inconsistencies in code during implementation and deployment. For example, contradictions between different versions of code can arise, leading to challenges in maintaining alignment across teams and environments during the deployment process. Traditionally, manual processes have been used to track code modifications and ensure adherence to compliance and governance protocols prior to software deployment. These manual methods depend on human attestation for verifying compliance with risk management and quality assurance requirements, which introduces various limitations. Human evaluations are prone to subjectivity, leading to inconsistencies in record-keeping and governance enforcement across different teams. Additionally, manual oversight is particularly susceptible to falsified attestations or errors or biases, posing significant risks to the integrity and security of the software being developed.

As organizations scale up and the number of application components increases, these challenges are further amplified. Relying on manual processes to manage hundreds or even thousands of components leads to inefficiencies, bottlenecks in the software development lifecycle, and an elevated risk of non-compliance with governance standards. Given the accelerated pace at which software is now developed and deployed, manual governance systems are no longer sufficient to meet the demands for precision, speed, and scalability.

‘Policy as code’ addresses these limitations by encoding governance policies and risk compliance requirements into machine-readable, executable rules. This enables organizations to automate the validation and enforcement of policies throughout the software development lifecycle. These processes may enhance the deployment of software changes by reducing conflicts and minimizing associated errors. Policy as code provides consistency, scalability, and transparency in compliance checks, significantly reducing the risk of human error and subjectivity. Automated systems can also monitor and audit code changes in real time, offering a more robust and reliable framework for verifying compliance and security standards. By transitioning from manual, human-driven governance to automated systems based on policy as code, organizations can more effectively manage the complexities of modern software development, ensuring uniform application of risk and compliance measures across all projects.

### SUMMARY

The disclosed embodiments describe systems and methods for providing an automated governance platform for software development. A user selection of a policy of a plurality of predefined policies associated with an application may be received by at least one processor. The selected policy may include policy code that provides a level of restriction or permission of a change to code provided by a user during the software development. A user selection of a current version or a previous version of the selected policy may be selected. The policy code for at least one of a plurality of policy requirements associated with the selected version of the selected policy may be compared to the code provided by the user. Based on the comparison, an outcome of the application may be determined. The outcome may include a plurality of respective outcomes corresponding to each of the plurality of policy requirements. Each of the plurality of respective outcomes may be indicative of whether each corresponding one of the plurality of policy requirements is satisfied, not satisfied, not required, or unavailable. The outcome of the application may be provided. The outcome may restrict or permit the change to the code.

According to some embodiments, providing the respective outcome may include detecting an event in the software development of the application. The providing may include capturing and digitally signing the event. The providing may also include storing the event. The providing may also include creating a system record of the stored event. The system record may further include metadata associated with the stored event.

According to some embodiments, providing the respective outcome may include transmitting the system record on a code development pipeline. At least one control attestation may be based on the metadata. Consistent with some of these embodiments, a result of the at least one attestation may be displayed via a graphical interface. The graphical interface may include an interactive button representing the result.

According to some embodiments, a policy change to one of the plurality of policy requirements may be received. By the at least one processor, the change to the code or the policy change may be implemented according to a trunk-based development branching strategy.

According to some embodiments, at least one policy of the plurality of predefined policies may be a user defined policy. Consistent with some of these embodiments, upon a third user selection of an interactive button on the graphical interface, a window of the graphical interface may be displayed and a user provided modification to the at least one policy may be received via the window.

According to some embodiments, a plurality of policy requirements may be specified in a PAC file. The PAC file may be adaptable according to a respective application and/or policy.

According to some embodiments, the plurality of policy requirements may be specified in a proxy auto-configuration file (PAC file), wherein the PAC file is adaptable according to the application or the policy.

The disclosed embodiments describe systems and methods for providing an automated governance platform for software development. By the at least one processor, a first user selection may be received, via a graphical interface, of a policy of a plurality of predefined policies associated with an application. The selected policy may include policy code that provides a level of restriction or permission of a change to code provided by a user during the software development. By the at least one processor, a second user selection may be received, via the graphical interface, a version of a plurality of versions of the selected policy. The graphical interface may include a selectable listing of the plurality of versions including a respective version date and name. By the at least one processor, the policy code may be compared for at least one of a plurality of policy requirements associated with the selected version of the selected policy to the code provided by the user. By the at least one processor, based on the comparison, an outcome of the application may be determined. The outcome may include a plurality of respective outcomes corresponding to each of the plurality of policy requirements. Each of the plurality of respective outcomes may be indicative of whether each corresponding one of the plurality of policy requirements is satisfied, not satisfied, not required, or unavailable. The graphical interface may be provided the outcome of the application. The outcome may restrict or permit the change to the code. The graphical interface may include a plurality of interactive buttons representing the respective outcome.

It is to be understood that both the foregoing general description and the following detailed description are exemplary and explanatory only, and are not restrictive of the disclosed embodiments, as claimed.

### BRIEF DESCRIPTION OF THE DRAWINGS

The accompanying drawings, which are incorporated in and constitute a part of this specification, illustrate disclosed embodiments and, together with the description, serve to explain the disclosed embodiments. In the drawings:

FIG. 1 depicts an administrator wishing to have a scalable way to manage the software development lifecycle, in accordance with the disclosed embodiments.

FIG. 2 depicts an administrator using an automated governance system, in accordance with the disclosed embodiments.

FIG. 3 depicts conventional (left) and disclosed (right) methods of releasing code over time, in accordance with disclosed embodiments.

FIG. 4 depicts an exemplary code development pipeline, in accordance with disclosed embodiments.

FIG. 5 depicts a diagram of an exemplary branching strategy for implementing changes to code, in accordance with disclosed embodiments.

FIG. 6 depicts a diagram of an exemplary branching strategy for implementing a rapid release of a software patch, in accordance with disclosed embodiments.

FIG. 7 depicts various components of a framework for an automated governance system, in accordance with disclosed embodiments.

FIG. 8 depicts a flow of an exemplary process for updating or changing a PAC file, in accordance with disclosed embodiments.

FIG. 9A depicts a flow of exemplary pre-production continuous integration/continuous development (CI/CD) pipelines associated with changes, in accordance with disclosed embodiments.

FIG. 9B illustrates an exemplary flow of promote and release pipelines associated with PaC Changes, which may be implemented after the pre-production CI/CD pipelines discussed with respect to FIG. 9A, in accordance with disclosed embodiments.

FIG. 10 depicts a chart illustrating a relationship between events and attestations, in accordance with disclosed embodiments.

FIG. 11 illustrates an exemplary graphical user interface (“GUI”) depicting a home screen listing a variety of mnemonics, each mnemonic being associated with a given application or component, in accordance with disclosed embodiments.

FIG. 12 illustrates an exemplary GUI depicting a landing screen when a user selects one of the mnemonics listed on a home screen, such as, e.g., the home screen depicted in FIG. 11, in accordance with disclosed embodiments.

FIG. 13 depicts an exemplary user interface displaying a dashboard having a variety of gating controls, in accordance with disclosed embodiments.

FIG. 14 depicts an exemplary user interface displaying a dashboard associated with a previous version of a given component, in accordance with disclosed embodiments.

FIG. 15 depicts an exemplary user interface displaying a scorecard associated with a full set of applications and corresponding components, in accordance with disclosed embodiments.

FIG. 16 depicts an example system environment for an automated governance system, in accordance with disclosed embodiments.

FIG. 17 illustrates an example process for using an automated governance system, in accordance with disclosed embodiments.

FIG. 18 illustrates an example process for using an automated governance system through a graphical user interface, in accordance with disclosed embodiments.

FIG. 19 depicts an example of a computing device, in accordance with disclosed embodiments.

### DETAILED DESCRIPTION

Reference will now be made in detail to exemplary embodiments, discussed with regard to the accompanying drawings. In some instances, the same reference numbers will be used throughout the drawings and the following description to refer to the same or like parts. Unless otherwise stated, technical and/or scientific terms have the meaning commonly understood by one of ordinary skill in the art. The disclosed embodiments are described in sufficient detail to enable those skilled in the art to practice the disclosed embodiments. It is to be understood that other embodiments may be utilized and that changes may be made without departing from the scope of the disclosed embodiments. For example, unless otherwise indicated, method steps disclosed in the figures may be rearranged, combined, or divided without departing from the envisioned embodiments. Similarly, additional steps may be added or steps may be removed without departing from the envisioned embodiments. Thus, the materials, methods, and examples are illustrative only and are not intended to be necessarily limited.

The disclosed embodiments improve upon conventional techniques by introducing an automated governance system that monitors the software development lifecycle to ensure quality and risk compliance. Risk compliance may refer to an organization's adherence to regulatory standards and best practices. For example, the automated governance system can maintain a centralized, immutable record-keeping system to guarantee the legitimacy, security, and expected performance of software components. By tracking critical details about application code, the system generates tamper-proof records that create an auditable trail of data and metadata for all events leading up to software deployment. This approach enables fast or fully automated software releases while ensuring that all components meet security, safety, and compliance requirements, enhancing both efficiency and oversight.

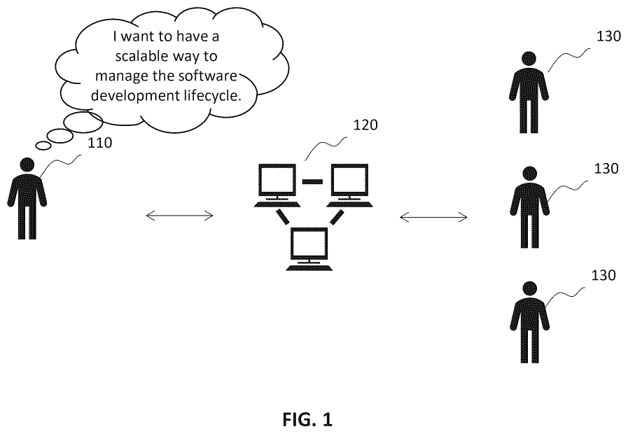

FIG. 1 depicts administrator 110 wishing to have a scalable way to manage the software development lifecycle, in accordance with the disclosed embodiments. Administrator 110, as used herein, may be any person responsible for the upkeep, management, maintenance, or quality of software development. Administrator 110 may operate or manage various protocols or tools through network 120 to control access of each of a plurality of users 130 to various aspects of software development. Users 130 may be any persons partaking in the software development lifecycle. Users 130 may include software developers or programmers. A software development lifecycle may be a structured process to design, develop, test, and deploy software or software systems.

Network 120 may include communications that take place across various types of networks, such as the Internet, a wired Wide Area Network (WAN), a wired Local Area Network (LAN), a wireless WAN (e.g., WiMAX), a wireless LAN (e.g., IEEE 802.11, etc.), a mesh network, a mobile/cellular network, an enterprise or private data network, a storage area network, a virtual private network using a public network, a nearfield communications technique (e.g., Bluetooth, infrared, etc.), or various other types of network communications. In some embodiments, the communications may take place across two or more of these forms of networks and protocols. Network 120 may also include a cloud network. A cloud network or cloud computing environment may be a distributed infrastructure that allows users to access, manage, and communicate with resources hosted in the cloud, such as data storage, computing power, or applications. This infrastructure often spans multiple geographic locations and data centers, enabling scalability, redundancy, and high availability of services. By utilizing a cloud network, organizations may dynamically allocate resources, streamline operations, and enhance connectivity across global regions, providing users with seamless access to cloud-based solutions.

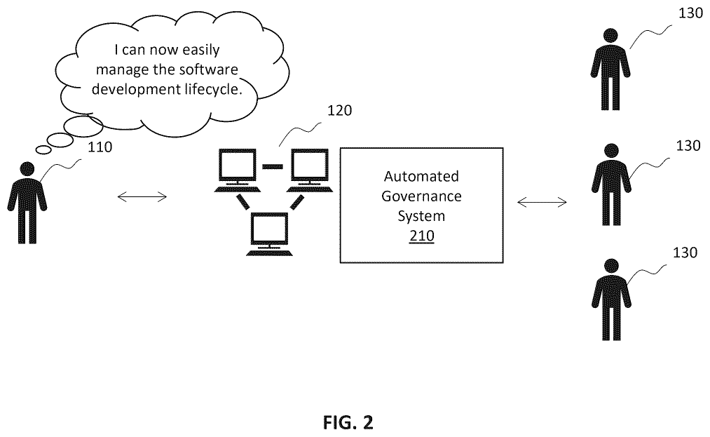

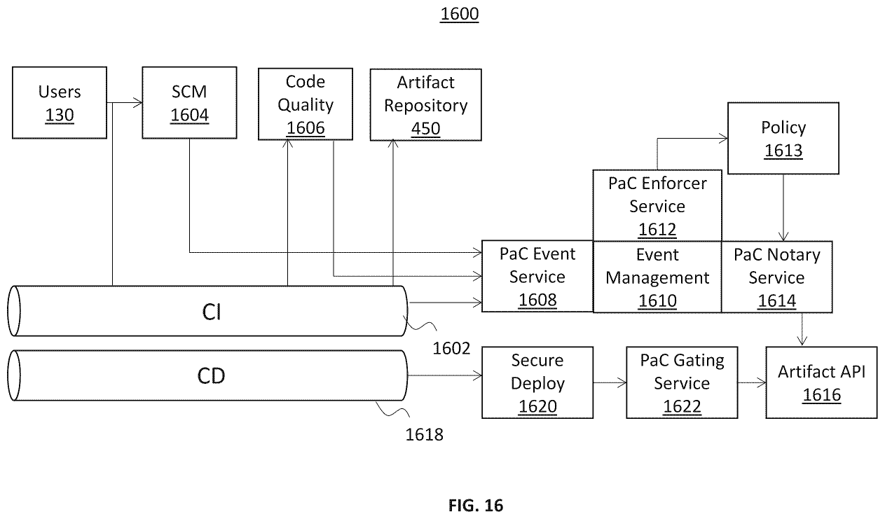

FIG. 2 depicts an administrator using automated governance system 210, in accordance with the disclosed embodiments. Automated governance system 210 may operate over network 120 or be deployed at any node associated with network 120. For example, a node on network 120 may include computers or other devices (e.g. the computer of FIG. 16). Automated governance system 210 may be a software-driven framework designed to manage, enforce, or monitor organizational policies, standards, or regulations throughout the software development process. By automating governance, the system may enable scalability, making it highly suitable for large organizations where multiple developers work on different software components. This automation may ensure that each developer's contributions are properly characterized, organized, and compliant with established policies, reducing the risk of errors and inconsistencies (e.g., avoiding overlapping software releases), while improving overall development efficiency.

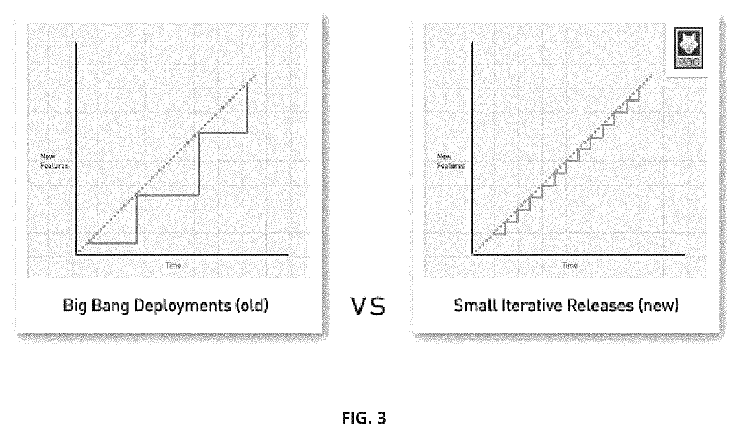

FIG. 3 depicts conventional (left) and disclosed (right) methods of releasing code over time, in accordance with disclosed embodiments. Releasing code may refer to providing code to a live environment where the code may be used by end-users. A live environment may be a production environment where the final version of the application or system is actively used by end users. As depicted on the left-hand side of FIG. 1, conventional methods may use “big bang deployments” of code. Under these conventional methods, longer periods of time may lapse between deployments of new code and each deployment of code may include more changes in the features provided by the code. As depicted on the right-hand side of FIG. 1, embodiments of code deployments as disclosed herein may involve “small iterative releases” of code. In such embodiments, code may be released more quickly and at a higher frequency, with smaller developments of the features deployed in each iterative release. The embodiments disclosed herein may allow for the quicker release of code that is secure, high quality, and compliant with regulations. Quick releases of small software changes may be better than big bang releases for several reasons: faster feedback, allowing teams to address issues promptly, and reducing the risk of major errors since fewer changes are involved. Incremental updates may improve the agility of a software development team, enabling the team to respond to user needs and market shifts quickly. In addition, troubleshooting may be made easier when using quick releases because there are fewer changes to review, and deployments may be smoother with less risk of system disruption. This approach may promote continuous improvement, resulting in a more reliable and stable software development process. These embodiments may also reduce potential conflicts of code changes that may arise due to work being split between various team members. Embodiments of the present disclosure may enable components of an application that are fully compliant to release to production by running a promote and release pipeline. A promote and release pipeline may be a structured sequence of processes and stages through which code moves from development to production. For example, a system consistent with the disclosed embodiments (e.g., automated governance system 210 of FIG. 2) may be used to facilitate the quick release of code that is high quality and compliant.

Disclosed embodiments may involve an automated governance system that may monitor the software development lifecycle to ensure quality and risk compliance. The disclosed embodiments may increase the speed of deploying software that is secure by creating fast feedback loops that may empower users to deliver new features quickly and securely. Fast feedback loops may refer to quickly receiving and acting on feedback during software development. The disclosed embodiments may promote an iterative approach that may streamline and automate a governance process as the process relates to developing and deploying new software. The disclosed embodiments may track information that may concern an application's code, such as, for example, its authors, dependencies, vulnerabilities, and testing performance. The disclosed embodiments may span the entire software development lifecycle. In some embodiments, each event detected in the software development lifecycle may be captured and digitally signed before it may be stored to create a system record. Digitally signed may refer to techniques to authenticate the identity of the individual or organization that created a piece of software. The system record may store metadata associated with the event. Metadata may be structured information that describes, explains, or otherwise provides context for data, making the data easier to locate, manage, and use. Metadata may serve as a component in data management and organization, facilitating the retrieval and use of information across various systems. The system records may be used to provide an auditable trail of metadata for the events preceding the deployment of a component of a software application. An auditable trail may be a systematic, chronological record of activities, events, or transactions that provides evidence of the sequence and details of actions taken within a system. The disclosed embodiments may remove human attestation of risk compliance and quality assurance to remove subjective decision making and record keeping from the software development process. In some embodiments, the disclosed embodiments may utilize cloud-native technologies, such as Open Policy Agent, Go, gRPC, Knative, kafka, kubernetes, and cloud-native technologies suitable for developing and deploying software code. Software code may be a set of instructions written in any programming language that is executed by a computer or other computing device to perform specific tasks or functions. Programming language may include Python, Java, C++, C, etc. Cloud-native technologies may refer to a collection of tools, practices, or architectures that are designed to build and run scalable applications such as cloud networks. The disclosed embodiments may further support custom-developed software applications across a variety of businesses. These application include, but are not limited to, Ephemeral Jenkins™ and Azure DevOps™.

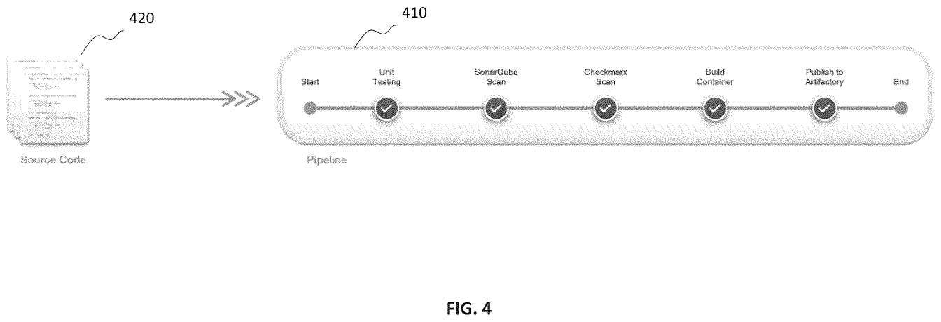

FIG. 4 depicts exemplary code development pipeline 410, in accordance with disclosed embodiments. Code development pipeline 410 may be a structured or automated sequence of processes through which software code progresses from development to deployment. The steps shown in code development pipeline 410 are merely exemplary and are not limiting. Code development pipeline 410 may be accessible from an interactive dashboard provided on one or more devices consistent with the disclosed embodiments. For example, the interactive dashboard may be employed on automated governance system 210, of FIG. 2, and engaged by administrator 110 or user 130 of FIG. 1. For example, the interactive dashboard may include a graphical user interface (GUI). A GUI may be a visual way to allow a user to interact with software using various graphical elements, including text, windows, icons, buttons, sliders, menus, links, audio, or visual elements.

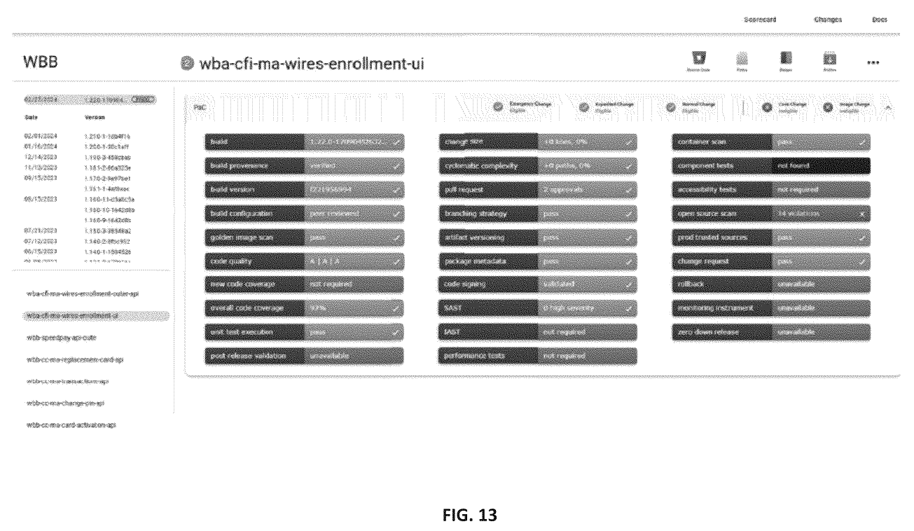

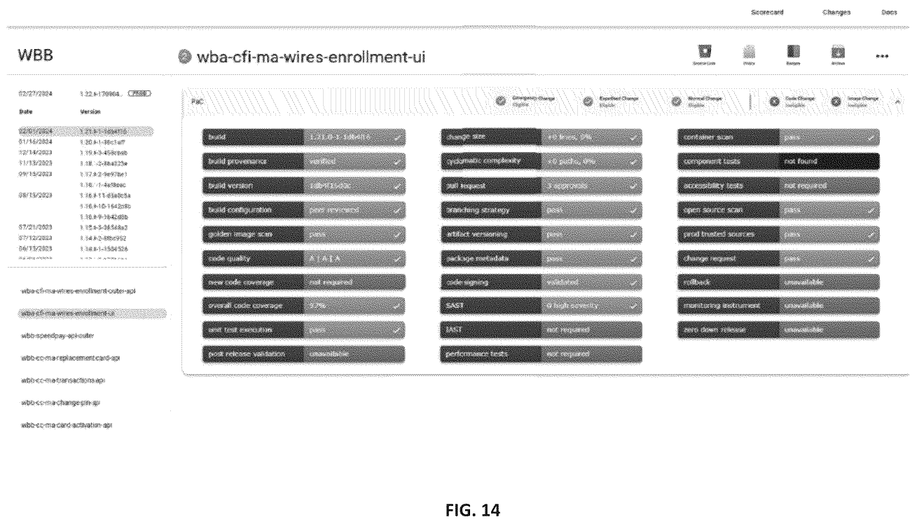

The code development pipeline of FIG. 4 may capture data from a continuous development (CD) or continuous integration (CI) pipeline related to the deployment of code. Continuous integration pipeline may refer to an automated process to help develop, integrate, or test code changes continuously. Code development pipeline 410 may also capture pull requests, SonarQube™ scans, Sysdig™ scans, and Checkmarx™ scans. Pull requests may refer to a mechanism for a developer to try to incorporate code into a software environment. For example, a developer may initiate a pull request to propose changes to software code. SonarQube™ scans may analyze code quality by detecting bugs, vulnerabilities, etc. Sysdig™ scans may be scans that assess software or cloud security by providing visibility into vulnerabilities, compliance, or performance metrics. Checkmarx™ scans may be a security testing solution that analyzes source code for vulnerabilities. Code development pipeline 410 may incorporate a DevOps toolchain used in the delivery, development, and management of software applications. The DevOps toolchain may be the tools used for a developer to plan, update, add, or manage code. In some embodiments, system record with metadata may be transferred to code development pipeline 410, which may capture event metadata to create control attestations. A result of an attestation may be displayed on a GUI with an interactive button representing a result (e.g., see FIGS. 13-14). Control attestations may be the formal process by which an organization verifies and affirms that specific controls (e.g., controls related to compliance, risk management, or security) are in place, operating effectively, and conforming to established standards or regulatory requirements. In some embodiments, code development pipeline 410 may utilize cloud-native technologies, such as Open Policy Agent™, Go, gRPC™, Knative™ Kafka™, Kubernetes™, or cloud-native technologies suitable for developing and deploying code. Code development pipeline 410 may further support custom-developed software applications across a variety of businesses, including, but not limited to, Ephemeral Jenkins™ and Azure DevOps™.

As depicted in FIG. 4, source code 420 associated with an application may be onboarded to code development pipeline 410, consistent with disclosed embodiments. Source code 420 may be the human-readable set of instructions written by developers in a programming language that defines how a software program or system operates. After source code 420 is onboarded to code development pipeline 410, code development pipeline 410 may automatically enter an “Event Capture Mode.” The event capture mode may include a period of observation to confirm that source code 420 is compliant with requirements of code development pipeline 410. The requirements (e.g., policy requirements) for code development pipeline 410 may be determined by factors such as project goals, development methodology (e.g., Agile or DevOps), compliance or security standards, team structure, the chosen technology stack, or the need for testing (e.g., unit or integration). A user may make changes to source code 420 during the event capture mode period to ensure that source code 420 meets the requirements of code development pipeline 410. During event capture mode, every CD or CI pipeline build on the primary branch of a component may be captured by code development pipeline 410. As discussed previously, code development pipeline 410 may also capture pull requests, SonarQube™ scans, Sysdig™ scans, and Checkmarx™ scans. The pull requests and scans may produce results for controls that may be required for a policy as code standard change. Policy as code (PC) may refer to a practice using policies or rules to manage code in a software development lifecycle. Standard change may refer to updating or modifying rules. A user (e.g. one of users 130 of FIG. 1) may track the progress of code development pipeline 410 through a “PC” dashboard. After the event capture mode is complete, the source code may be eligible for a deployment gating mode, which may allow for execution of a PC standard change. Deployment gating mode may refer to a strategy used in software deployment to control and restrict the release of new code changes. Deployment gating mode may be used to establish a controlled process for releasing new code changes, ensuring that only thoroughly tested and compliant updates reach production environments. This strategy may reduce the risk of introducing bugs or vulnerabilities and may help to maintain quality code by allowing teams to assess the readiness of changes before deployment. For example, PC standard change may be performed by automated governance system 210. PC may include use of predefined policies associated with an application. Predefined policies may be a set of rules or guidelines that are defined in a machine-readable format and used to govern the behavior of applications or infrastructure. These policies may be created in advance to enforce security, compliance, operational, or organizational standards automatically within a software development or deployment pipeline. In some embodiments, at least one policy of the predefined policies may be a user-defined policy. Upon a user selection of an interactive button on a GUI, a window of the GUI may be displayed and a user modification may be received via the window. Such policies may allow organizations or users to customize governance, compliance, or operational rules according to their specific needs. Unlike standard, built-in policies, these user-defined policies may be created to address unique requirements, such as enforcing custom security protocols, managing resource usage, or ensuring compliance with niche industry regulations. By integrating these custom policies into an automated governance system, organizations may ensure that their specific rules are automatically enforced, providing flexibility while maintaining consistency and control throughout the software development or operational lifecycle.

Before executing a PC standard change, various automated controls may be checked. Automated controls may be predefined, programmatically enforced rules or checks that ensure compliance with security, regulatory, and operational standards throughout the software development lifecycle. In some embodiments, any code change may be required to pass all relevant controls associated with the PC standard change, as dictated by one or more predefined rule sets. In other embodiments, passing all controls may not be a requirement for a code change. For example, if a component is part of an internet-facing application, changes to that component may be required to pass all controls. However, if the component is not internet-facing, the code changes may not need to meet all control requirements.

In some embodiments, unlike standard changes, emergency changes or expedited changes may be exempt from gating requirements. Emergency changes may be unplanned modifications made to address critical issues or vulnerabilities that may require immediate attention. Expedited changes may be prioritized modifications or updates to be implemented more quickly than standard procedures normally allow. For example, expedited changes may be used to meet urgent business needs. To become eligible for deployment gating mode, all (or at least specific) application components may be required to be in full compliance with the requirements of the disclosed embodiments. Using deployment gating mode, the requirements of the disclosed embodiments may gate (e.g., block) production or code deployments for application components. For example, deployment gating mode may be used to check that a code change is compliant with policy requirements determined by an administrator. Any application components that are onboarded to the disclosed embodiments may be gated if non-compliant. Deployment gating mode may also include rollout phase gates, which may enable the gating (e.g., blocking) of artifacts (e.g., non-compliant artifacts, or all artifacts) compiled on or after a start date of a given phase of rollouts. An artifact may be source code, a data model, a prototype, a workflow diagram, a design document, or any other component that may be created during the software development process. Building the artifact may be the part of a software development lifecycle where code is compiled, assembled, or packaged into a deployable software. If an application deployment is gated during the deployment gating mode, a user (e.g. users 130 of FIG. 1) may review the reasons for gating (e.g., which policy requirements include violations, and what those violations are), remediate the indicated failures (e.g., violations), and then attempt to redeploy the application.

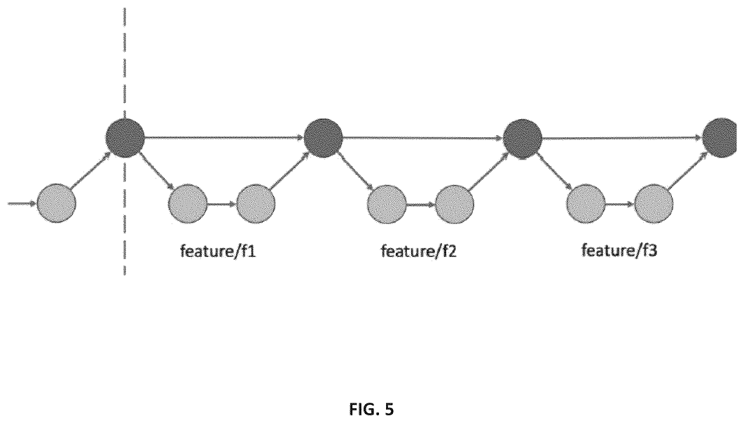

FIG. 5 depicts a diagram of an exemplary branching strategy for implementing changes to code, in accordance with disclosed embodiments. The diagram highlights a trunk-based development model, which may be used to manage these changes. In this approach, all code developments may be merged into a central “main branch.” Developers (e.g., users 130 from FIG. 1) may work on individual features or fixes within separate branches. For instance, a feature “f1” may be developed in an isolated branch and then merged into the main branch once the feature is complete. Afterward, feature “f2” may be developed based on the updated main branch and merged similarly. This sequential approach may be continued for feature “f3” and beyond. Trunk-based development ensures that each change is systematically merged, keeping the main branch up-to-date and preventing confusion caused by overlapping or uncoordinated changes. By merging directly into the main branch, this method may promote a clean, well-organized sequence of code changes that complies with automated controls and avoids potential conflicts or mismanagement in the development process. Team members often work simultaneously, resulting in overlapping tasks that can complicate the merging and organization of branches. This highlights the need for a system that effectively manages policy checks and enforces software development gating, as for the automated governance system described herein.

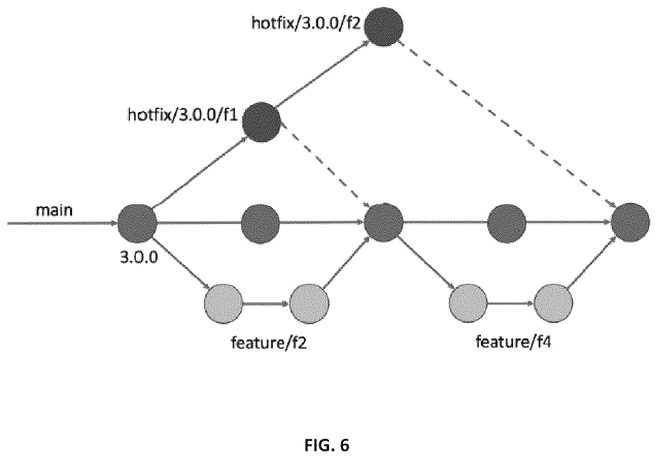

FIG. 6 depicts a branching strategy for implementing a rapid release of a software patch in accordance with the controls of the PC standard change. For example, FIG. 6 may depict a trunk-based development branching strategy that may be used for bug fixes in code or any other changes to code that may require a rapid release. A rapid release change to code, such as “hotfix/3.0.0/f1,” may be made to the main branch of code and may be merged back to the main branch to keep the main branch up to date. A rapid release change to code may be the quick implementation and deployment of updates or modifications to software code. If an additional rapid release is needed, such as “hotfix/3.0.0/f2,” then the rapid release change may be branched from the previous rapid release change, such as “hotfix/3.0.0/f1.” The additional rapid release change may then also be merged back to the main branch.

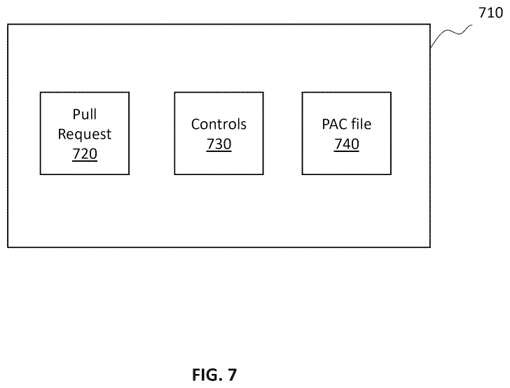

Disclosed embodiments may include various components of a framework for PC that may help automate the governance and compliance policies in software development. FIG. 7 depicts various components of framework 710 for an automated governance system, in accordance with disclosed embodiments. Pull request 720, as described previously, may move software between branches. Controls 730, such as pull requests, build control, versioning, security scanning, and compliance validation, may be applied throughout the development lifecycle. Build control may be the management or oversight of compiling or assembling source code into deployable software. Versioning may be assigning unique version numbers to different iterations of software or documents (e.g., for software or artifacts). Security scanning may be systematically analyzing code, binaries, or applications to identify vulnerabilities or ensure compliance. Compliance validation may be ensuring that software adheres to predefined regulations, standards, or policies throughout its development and deployment lifecycle. Also, controls 730, such as static code quality, security scans, and versioning of artifacts, may help ensure that code changes meet security and quality standards before deployment. Static code quality may be the assessment of source code without executing it (e.g. for testing securely). Policies may be stored in Proxy Auto-Configuration (PAC) files 740, which may define the necessary requirements for each application component, allowing for structured governance and audit trails while promoting efficiency and security.

Some embodiments may involve pull request 720. Pull request 720 may include a proposal to merge a set of changes from one branch to another. Pull request 720 may allow for review of proposed changes before the changes are integrated into a main branch. Any change to the main branch of a code repository may be made through pull request 720. A code repository may be any place code is stored in a computing environment. For example, code may not be allowed to be directly committed to the main branch but may first go through a code repository. Each pull request 720 may require the number of required approvals listed in the corresponding PAC file 740 before pull request 720 may be merged into the repository's primary branch. PAC file 740 may be a type of file providing a secure means to store a manifest of policy obligations that define requirements for an application to be considered compliant. PAC file 740 may include information such as application programming interface (API) version, ID, type, mnemonic (name), or inheritance of file propertiess. An API may be any software used to interface or exchange information between two or more computer programs or devices.

Some embodiments may involve a build control in controls 730. Each type of build file in build control may have a required format. A build file may be a script or configuration file that contains instructions for compiling and packaging source code into a deployable software artifact, often specifying dependencies, build processes, and the output format. A component's build group values may be required to match across build files. Build group values may be the set of parameters or configurations that define how software artifacts are compiled, packaged, or deployed within a specific group or environment in the software development process. For example, a component may fail the build control if the specified group value differs from the group value in the build files. A component may pass the build control if the specified group value matches the group value of the build file.

Some embodiments may involve a “provenance of build” control in control 730. The provenance of build control may transmit build events to the system of the disclosed embodiments to confirm the provenance of a build. Provenance of build may refer to a detailed record of how a build was created, including any metadata. For example, this control may provide an attestation of the entity that produced or invoked the build. Application components that are onboarded to the disclosed embodiments may include a verified audit trail. The verified audit trail may include metadata describing the build that created the update to the component. A verified audit trail may be a detailed record of activities or changes in a system.

Some embodiments may involve build versioning in controls 730. Build versioning may refer to assigning unique version identifiers to different builds. Versions may represent each iteration of a change. For each component onboarded to the automated governance system of framework 710, may verify that the build files are version controlled (e.g., stored in source control). To pass this control, the updated component may be required to provide a git commit hash associated with the last change to each build script. Additionally, each component's PAC file 740 may be required to enumerate every file that contributes to building the artifact.

Some embodiments may involve a build configuration peer review in controls 730. A build configuration peer review may be a review process where users review any code, including the outcome of building the artifact. Any change to a build file may undergo a peer review via a pull request. The peer review may help to ensure that changes to a build file are examined by one or more colleagues before they are merged into the main codebase. The automated governance system of framework 710 may traverse the build files listed in build versions and verify for each that the last commit was a merged pull request that contained the minimum count of approvals. This control may apply to each of the build files listed in the build version of PAC file 740 associated with the application component.

Some embodiments may involve an artifact versioning control in controls 730. Artifact versioning control may be an approach of managing or tracking different versions of build artifacts through the software development lifecycle. The artifact versioning control may require each artifact associated with a component to be versioned according to a predefined scheme. The predefined scheme may include any combination of words, letters, numbers, or other forms of identifiers that may be used to identify a version of an artifact. For example, the predefined scheme may include semantic versioning. Semantic versioning may be making version numbers include context, providing some meaning in the version numbering. Semantic versioning may structure each version identifier into three parts: major, minor, and patch.

Some embodiments may involve a production trusted sources control in controls 730. Production trusted sources control may be processes for managing the security, integrity, and reliability of code and artifacts. Under the production trusted sources control, the disclosed embodiments may verify that a component's artifact was published to a “release” repository. A component may not be deployed to production from a “stage” repository. A component may be published to the appropriate “release” repository during a successful execution of a promote pipeline (i.e., a CD or CI pipeline). A promote pipeline may be designed to handle the transition of code or artifacts from one environment to another. For example, promoting within the pipeline may occur going through development from testing to staging to production of the code.

Some embodiments may involve a required package metadata control in controls 730. A required package metadata control may be managing metadata associated with software packages to ensure that the software is correctly defined and compliant. The required package metadata control may verify that all necessary artifact metadata exists and is stored. This control may be passed when the metadata associated with an artifact is properly stored.

Some embodiments may involve a digital code signing control in controls 730. The digital code signing control may ensure that each artifact produced is digitally signed. In some embodiments, the artifact may be digitally signed using a cryptographic key or digital certificate, such as those created using Venafi™ software. To pass this control, the signature on the artifact may be required to be a matching SHA-256 value.

Some embodiments may involve a static code quality analysis in controls 730. The static code quality analysis may be a combination of three SonarQube™ metrics: security, reliability, and maintainability. Each of these metrics may score a grade, such as a letter grade. All three of the metrics may be required to exceed a pre-defined threshold grade to pass this control.

Some embodiments may involve an overall code coverage control in controls 730. The overall code coverage control may determine the percentage of total lines of code that are covered by unit tests. This value may be computed by SonarQube™ for the application as a whole, rather than just the newly written code.

Some embodiments may involve a new code coverage control in controls 730. The new code coverage control may determine a percentage of new lines of code that are covered by unit tests. This value may be computed by SonarQube™ for the application component and may only take new code covered in the preceding 30 days into consideration.

Some embodiments may involve a unit test execution control in controls 730. The execution of unit tests may be evaluated through a test report. The unit test may include a software testing method to determine whether individual units of source code are fit for deployment. A unit test report may provide a summary of the unit tests run on the component.

Some embodiments may involve a change size control in controls 730. The change size control may determine the number of lines that have been changed since the previous component release. The change size control may be computed as an absolute value to take into account net decreases in lines of code as well as net increases in lines of code. The number of lines of code may be compared to a predetermined threshold. If the number of lines of changed code is below the predetermined threshold, then the component may pass this control. If the number of lines of changed code is above the predetermined threshold, then the component may fail this control.

Some embodiments may involve a cyclomatic complexity control in controls 730. The cyclomatic complexity control may include a SonarQube™ cyclomatic complexity rating. The cyclomatic complexity rating may include a measure of the number of linearly independent paths through a programs' source code. A path may be a unique route through the code that can be taken based on conditional statements. A linearly independent path may be a path that adds new information about the program's behavior that hasn't been covered by another path.

Some embodiments may involve a static application security testing (SAST) control in controls 730. The SAST control may validate that all application components are scanned for static security analysis. The SAST control may validate that no Critical or High vulnerabilities are found in the code. For example, a Checkmarx™ scan may be used as a part of this control. The Checkmarx™ scan may be a type of a SAST that analyze source code for vulnerabilities and security flaws, helping organizations identify and remediate potential risks in their applications before deployment. If a component is associated with a Critical or High level of vulnerability, then it may not be allowed to be deployed. A Static Application Security Testing (SAST) control may be required for mnemonics that may be Internet facing or IRR Tier 1 or 2.

Some embodiments may involve an Interactive Security Testing (IAST) control in controls 730. The LAST control may verify that the application component has no critical or high vulnerabilities and 100% route coverage. This control may be captured during application testing when a Contrast agent may be injected into the application component at runtime to monitor traffic between services. If a component has a Critical or High vulnerability, then it may not be allowed to be deployed. An IAST control may be required for mnemonics that may be Internet facing or IRR Tier 1 or 2. An IAST control may also not be required for a user interface component.

Some embodiments may involve a container scan in controls 730. A container scan may verify that a containerized application component was scanned has does not have any critical or high vulnerabilities before promoting the component to a release repository. A containerized application may be a software application that is packaged along with its dependencies and configurations into a container, allowing the application to run consistently across various computing environments regardless of the underlying infrastructure. If a component has not been scanned, then the disclosed embodiments may provision a scan and capture the results. If the component has a critical or high vulnerability, then it may not be allowed to be deployed. If a component is non-containerized, then that component may be exempt from the container scan control.

Some embodiments may involve a component test in controls 730. A component test control may include integration and regression testing in a quality assurance (QA) environment. Integration and regression testing may be a software testing process that ensures individual components or systems work together as intended and verifies that recent changes have not adversely affected existing functionalities.

Some embodiments may involve an accessibility test in controls 730. An application component having accessibility tests may perform those tests in the QA environment. The accessibility testing may ensure that the application component is useable for as many users as possible.

Some embodiments may involve an open source package/licensing scan in controls 730. An open-source package/licensing scan may evaluate software components to identify known vulnerabilities and ensure compliance with licensing requirements. For example, an application component may be subject to a Sonatype Nexus Lifecycle™ package security scan. Sonatype Nexus Lifecycle™ package security scan may be a tool that analyzes software dependencies to identify known vulnerabilities, license compliance issues, or overall security risks within open-source or third-party packages used in applications. Scan results may be required to contain less than a predefined threshold of violations. If a scan result determines that there are more violations than the predefined threshold, then the application component may not pass this control. If the scan result determines that there are fewer violations than the predefined threshold, then the application component may pass this control.

Some embodiments may involve a golden image scan in controls 730. Containerized application components may be subject to a golden image scan. A golden image scan may be a process that analyzes a pre-configured image used as a standard for deploying software across an organization. A golden image scan may evaluate a pre-configured container or software image to ensure the image meets security and compliance standards before deployment, identifying vulnerabilities or misconfigurations. For example, a golden image scan may use a standard template for a virtual machine to test code changes. Container images built within the CI pipeline may be required to be built from a CaaS golden image published within the preceding month. In some embodiments, the CaaS golden image may have been published within the preceding two months. A golden image scan control may be a vendor-supplied base image. A vendor-supplied base image may be a pre-built image provided by a software vendor or cloud provider that serves as a foundational layer for creating custom application or system images.

Some embodiments may involve a control evaluation retry functionality in controls 730. Control evaluation retry functionality may allow users to reattempt control evaluations in the event of integration issues with external services. The disclosed embodiments may integrate with external services for enrichment calls to gather information to perform control evaluations. Some controls may have integration problems with the external services. Therefore, a user may be able to retry a control evaluation using the same event payloads from the original evaluation. Once external tools have been updated or stabilized, a user may click a “retry” button within the failed control window. The user may receive a success or failure retry notification to indicate whether the evaluation flows have restarted or not.

Some embodiments may involve other controls in controls 730 associated with dynamic security testing, white-list non-production data source controls, automated rollback controls, monitoring instrumentation controls, automated provisioning controls, zero downtime release controls, and post release validation controls. Dynamic security testing may be a method of evaluating the security of an application by executing it in a runtime environment to identify vulnerabilities, flaws, or security risks through simulated attacks or automated scanning. White-list non-production data source controls may be security measures that restrict access to specific, approved data sources. Automated rollback controls may be mechanisms that automatically revert a system or application to a previous stable state in the event of a deployment failure or error. Monitoring instrumentation controls may be tools and processes that track, collect, and analyze performance metrics and logs from applications and systems in real time. Automated provisioning controls are mechanisms that enable the automatic setup and configuration of resources, such as servers or applications, based on predefined policies and requirements. Zero downtime release controls may be strategies and practices implemented during software deployments that allow for updates and changes to be made to applications without interrupting service or causing downtime. Post-release validation controls may be processes and checks conducted after a software release to ensure that the application is functioning as intended, meets quality standards, and adheres to compliance requirements.

Some disclosed embodiments may further evaluate and administer policies at an application component level (e.g., in controls 730). The policy requirements for each component may be specified in PAC file 740. In some embodiments, PAC file 740 may be adaptable according to an application or policy. As described earlier, PAC file 740 may include a declarative manifest of policy obligations that may define the necessary requirements for an application to be considered compliant. In some embodiments, PAC file 740 may be written in a human-readable data serialization language such as YAML.

As described earlier, the first block of PAC file 740 may define an API version, an identifier (ID), a type, a mnemonic, an inheritance of PAC file 740, or a version of PAC file 740. The PAC file ID may include a unique value that may represent the relationship between the application component and the disclosed embodiments. This value may not be changeable throughout the lifecycle of the application component. This value may include a combination of letters and numbers to identify PAC file 740.

In some embodiments there may be multiple types of PAC file 740 including, for example, mnemonic, profile, and component files. Type of PAC file 740 may determine its inheritance behavior. Inheritance of PAC file 740 may be designed to limit the amount of policy that must be written for each application component and allow different business groups to define policies at a mnemonic level. A component's PAC file policy may either inherit or override one or multiple other PAC files. Inheritance may be defined at the mnemonic level and the scope of the inheritance may be limited to the mnemonic level. Therefore, PAC file 740 may not be able to inherit a policy from a different mnemonic. A PAC file inheritance may be optional and may include one or more PAC files. Type of PAC file 740 may include a master PAC file, which may be a baseline for inheritance and may be limited to policies that reach all or most of the components in a mnemonic.

In some embodiments, profiles may be designed to accommodate various application component types within a mnemonic. Multiple profiles may be assigned to a component's PAC file 740. In the case of overlapping policies between profiles, the lattermost profile may override the former. A PAC file's policy definitions may be sorted by group. A policy group may be defined by the controls or policies that can be gathered from a certain resource of SDLC event.

A PAC file change may signify a change in compliance obligations for one or many application components. PAC file changes may be infrequent if security and compliance are a concern. PAC file 740 may be configurable for each application component.

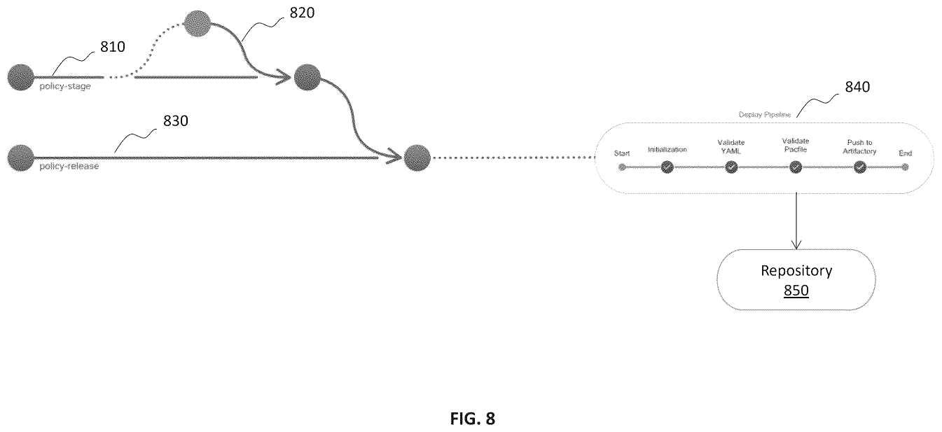

FIG. 8 depicts a flow of an exemplary process for updating or changing a PAC file, in accordance with disclosed embodiments. As depicted in FIG. 6, a branch may be created from a main branch (e.g., policy stage 810) where a policy change may be made (e.g., by creating a new PAC file or modifying an existing PAC file). In some embodiments, a policy change to one of the plurality of policy requirements may be received, and the change to the code or policy change may occur according to a trunk-based development branching strategy. Policy stage 810 may be a defined phase within a governance or compliance framework where specific policies are reviewed, evaluated, or implemented. Once the policy changes are complete, pull request 820 may be raised from the new branch, into policy stage 810. Pull request 820 from the branch may be approved by PC controls and permitted to merge with policy stage 810 for policy-release 830. This merge may begin deployment pipeline 840 to publish the new policy. A deployment pipeline may be a process that facilitates the CI and CD of code changes, enabling deployment of software to production environments. A new PAC file change may then be published to repository 850 where it may be accessed by the disclosed embodiments in real time. A repository may be a centralized storage location that manages and maintains various versions of software components, libraries, and packages, facilitating easy access, organization, and deployment within development and production environments. For example, the change may be published to an artifactory (e.g., JFrog Artifactory). An artifactory may be a manager of a repository for artifacts. For example, a repository may integrate with CI/CD pipelines. In some embodiments, to perform a PC standard change, an approved policy may be required. Once the policy is approved, components covered by the policy may be able to perform a PC standard change, as disclosed herein.

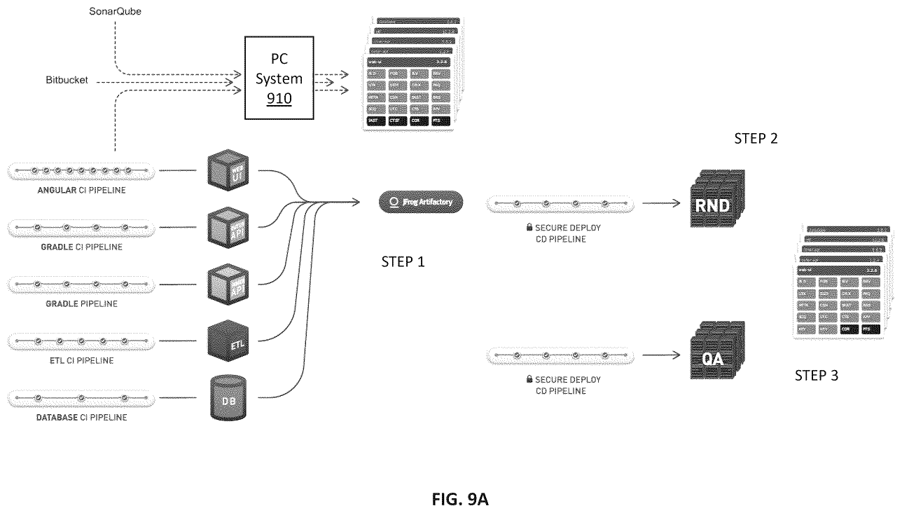

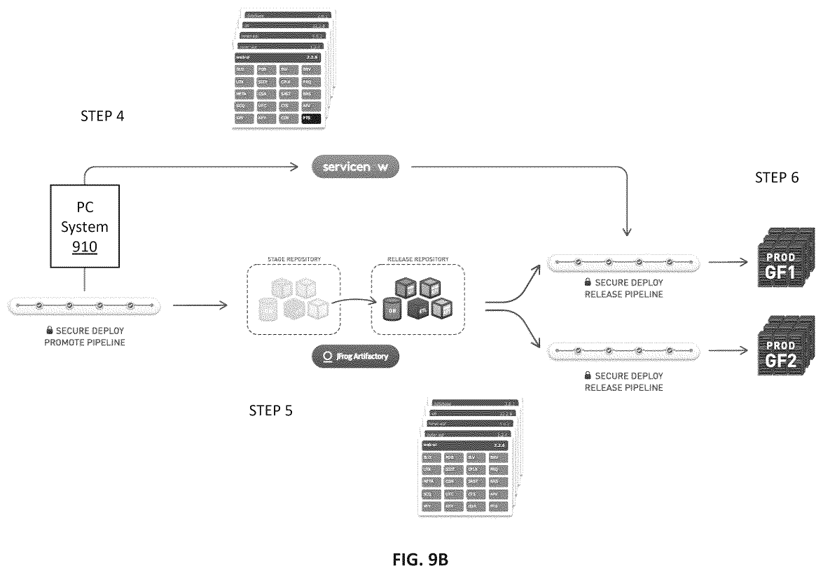

FIG. 9A depicts a flow of exemplary pre-production CI/CD pipelines associated with changes, in accordance with disclosed embodiments. The example of FIG. 9A may depict part of the operation of an automated governance system and is not intended to be limiting. As shown in FIG. 9A, events may be asynchronously streamed to PC system 910 throughout a CI pipeline. For example, code quality testing may include SonarQube™ scans and versioning control may include Bitbucket™ for various CI pipelines. Cl pipelines in FIG. 9A include Angular™ CI pipeline, Gradle™ CI pipeline, ETL™ CI pipeline, or a database CI pipeline. A database CI pipeline may integrate database changes, including schema modifications and data migrations, into the CI workflow. The PC dashboard may be updated automatically and dynamically based on the asynchronous streaming. Asynchronous streaming may refer to the process of transmitting data or events in real-time without requiring the sender and receiver to wait for each other. The PC dashboard for PC system 910 may include a GUI for displaying information to users (e.g., administrator 110 or users 130 of FIG. 1). For example, PC system 910 may be the automated governance system of FIG. 2.

In step 1 of FIG. 9A, trusted artifacts built during the CI pipeline may be published to a stage repository in an artifactory. For example, trusted artifacts may be reflective of software code changes from developers which have passed SonarQube™ tests. In step 2, a secure deployed CD pipeline may deploy the new artifacts to a research and development (RND) environment. In the RND environment, artifacts may be tested and validated. In step 3, the secure deploy pipeline may produce functional tests and IAST attestations (for policy requirements) to PC system 910 before deploying to a QA environment. In the QA environment, various controls or tests may be used (e.g., controls 730 of FIG. 7).

FIG. 9B illustrates an exemplary flow of promote and release pipelines associated with PC changes, which may be implemented after the pre-production CI/CD pipelines discussed with respect to FIG. 9A, in accordance with disclosed embodiments. FIG. 9B may depict part of the operation of an automated governance system and is not intended to be limiting. As shown in step 4 of FIG. 9B, a secure deploy promote pipeline may request PC system 910 to open a change request (e.g., in ServiceNow™) with attestations for each component. A secure deploy promote pipeline may be a structured, automated process used to transition code and artifacts from development through testing environments to production in a secure manner. If all components pass every risk control (e.g., policy requirement), PC system 910 may automatically approve the change request and attest to the automated change order risk control. Further, after a change request is opened, the secure deploy promote pipeline may move trusted artifacts from a stage repository to a release repository (e.g., in JFrog Artifactory). In step 5, the secure deploy release pipeline may deploy artifacts to production from the release repository. The moving of a trusted artifact to the release repository may also produce a risk control attestation (e.g., for the production trusted sources risk control). In step 6, one or more secure deploy release pipelines may verify an approved change request and deploy that change request to one or more production environments. For example, a production environment may be greenfield 1 or 2 (GF 1 or GF 2). These production deployments may be sent to the PC system which may record every deployment made via the secure deploy pipeline.

Accordingly, the PC system may employ a comprehensive suite of automated controls (as depicted in FIG. 7) to govern the software development life cycle while simultaneously enabling continuous delivery of code or software development. In some embodiments, additional governance may be needed, and custom controls (which leverage PC infrastructure) may be provided which run on top of the automated controls (i.e., the custom controls may inherit the automated controls, such as attestation and deployment gating). Furthermore, the PC system may maintain a stateless, event-driven architecture, and custom control integrations may also be expected to uphold such a design pattern. For this reason, when designing a custom control, the relationship between events and attestations may be considered as a design objective. A one-to-many relationship may be preferred (i.e., one event to many attestations); however, a one-to-one relationship or a many-to-one relationship may also exist. For example, to create a custom control, a user (e.g. users 130) may follow the following steps: (1) Define the event that will trigger the custom control and configure the event to send to an ingestion pipeline of the PC system; (2) Develop a serverless function for processing the event payload to convert the payload into a proper ingestion format; and (3) Write rules (e.g., using open policy agent) to evaluate the event metadata. When components are decommissioned or no longer required to be built or deployed (e.g., through the Enterprise Pipeline), such components may be offboarded, or archived. A user may offboard a component by taking the following steps: (1) Determine that a component is no longer required or decommissioned; (2) Submit an archival request via the PC component dashboard (once submitted, the request may enter a queue within the PC system); and (3) the PC system will then validate the archival request to ensure proper intent (and move the component to “archived” status). Although the component may be archived, all the component's risk control attestations may remain intact, and in the case of accidental archival, any archived component may be re-activated upon user request.

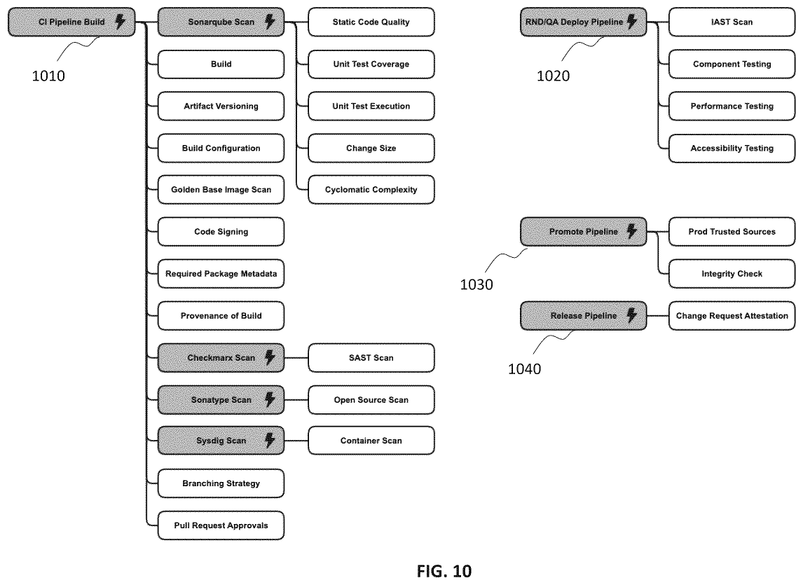

FIG. 10 depicts a chart illustrating a relationship between events and attestations, in accordance with disclosed embodiments. FIG. 10 is intended to be a non-limiting example. As illustrated in the example of FIG. 10, four events are responsible for a PaC control suite. and each of the four events may produce more than one attestation. In FIG. 10, dark gray boxes depict events while white boxes depict attestations. For example, CI Pipeline Build 1010 produces 17 attestations from a single event. The same event may also trigger four subsequent events leading to additional attestations (adding up to 17 total attestations, shown in white boxes). In addition, RND/QA Deploy Pipeline 1020 produces 4 additional attestations, Promote Pipeline 1030 produces 2 additional attestations, and Release Pipeline 1040 produces 1 additional attestation. A deploy pipeline may be a series of automated processes and stages that facilitate the deployment of software applications from development to production. A promote pipeline may be a process that enables the movement of software artifacts through various environments, such as development, testing, and production. A release pipeline may be a series of automated processes that prepare and deploy software artifacts to production environments

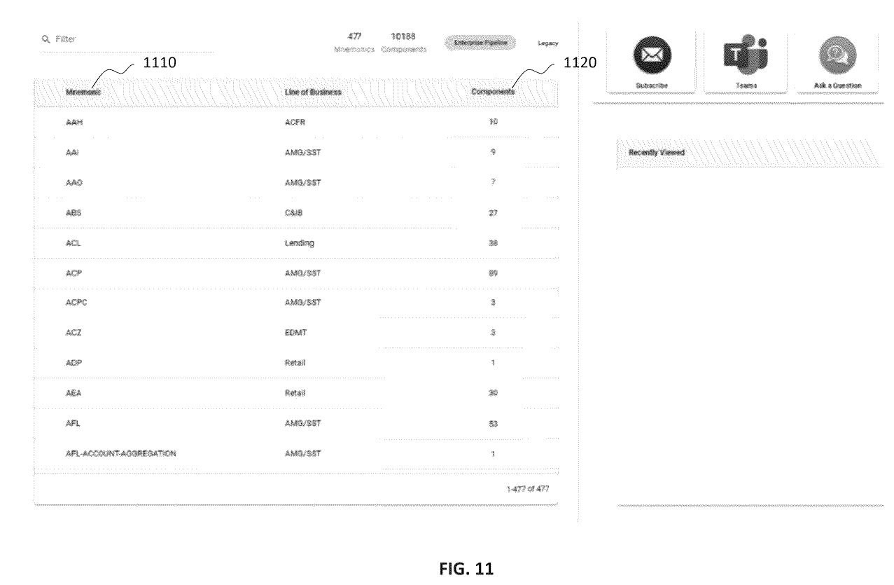

FIG. 11 illustrates an exemplary graphical user interface (“GUI”) depicting a home screen listing a variety of mnemonics 1110, each mnemonic 1110 being associated with a given application or component 1120, in accordance with disclosed embodiments. Mnemonics may be memory aids or an abbreviation for an operation. For example, a mnemonic may be ‘HQ’ for headquarters. Each given application may contain a variety of components 1120. Each component 1120 may include various source code for implementing a particular feature (or features) of the corresponding application. For example, using the exemplary GUI of FIG. 11, a user may select a listed mnemonic 1110 or search for mnemonic 1110 using the filter bar (or search bar). The exemplary GUI, as shown in FIG. 11, may also include a list of recently viewed mnemonics, as well as links to other applications.

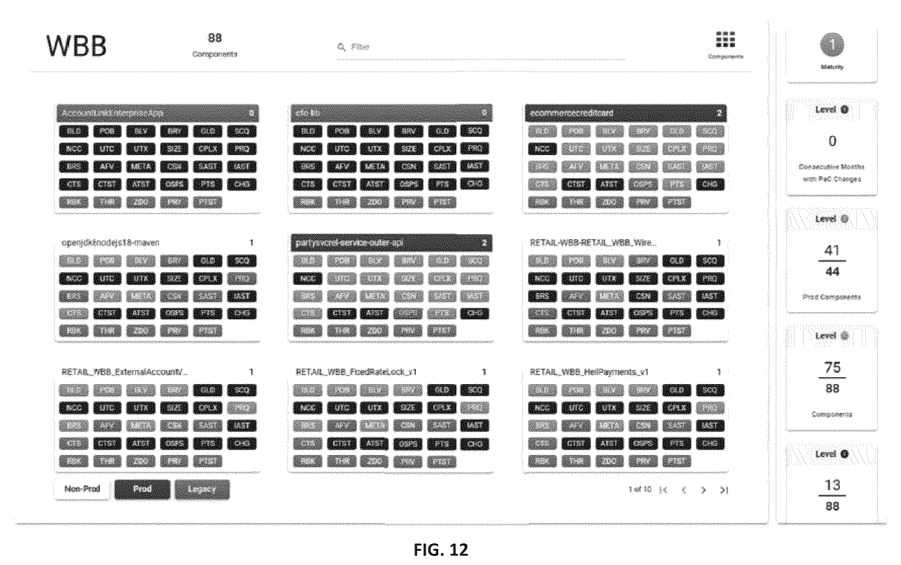

FIG. 12 illustrates an exemplary GUI depicting a landing screen when a user selects one of the mnemonics listed on a home screen, such as, e.g., the home screen depicted in FIG. 11. The exemplary landing screen of FIG. 12 lists a total of 88 components associated with a particular application (e.g., the application associated with the mnemonic, “WBB”). Each component may be displayed as an individual graphic, wherein each graphic includes buttons associated with particular policy requirements (e.g., tests which must be passed to comply with the policy). Each of these buttons may be associated with specific code that represents the policy (e.g., PC). As also shown in FIG. 12, a landing screen may also display a graphic listing the total number of components that have reached maturity, as well as the total number of components that have reached a particular level of compliance with the policy requirements. For example, the components may be grouped into one of Level 0, Level 1, Level 2, and Level 3.

FIG. 13 depicts an exemplary user interface displaying a dashboard with a variety of gating controls, in accordance with disclosed embodiments. As shown in FIG. 13, an exemplary second landing screen (e.g., following the landing screen of FIG. 12) may provide additional details regarding each policy requirement corresponding to that component, thereby providing a user with further information which may explain why a given policy requirement is met, not required, not found, unavailable, or not met.

FIG. 14 depicts an exemplary user interface displaying a dashboard associated with a previous version of a given component, in accordance with disclosed embodiments. By selecting different versions of the component, a user may be enabled to review the policy requirements associated with various versions of the component to understand what changes resulted in varying compliance levels with the policy requirements. For example, as shown in FIG. 14, the associated version of the component (i.e., the version dated Feb. 1, 2024) shows no violations of any policy requirement, while the version shown in FIG. 13 (i.e., the version dated Feb. 27, 2024) shows 14 violations of the “open source scan” policy requirement. As a result, a user may be able to understand that changes from the previous version caused the violations, review the changes between the two versions, and identify the source code leading to the violations.

FIGS. 13 and 14 show exemplary user interfaces (dashboards) displaying a variety of gating controls (e.g., policy requirements), wherein each gating control is associated with a particular PC. The exemplary user interface indicates whether each gating control is passed, failed, or not required (or unavailable), allowing a user to easily navigate those aspects of a given application component that require attention due to non-compliancy with policy. By regularly monitoring the compliance of application components via the PC dashboard, a user (e.g., developer) may remediate failed controls as indicated in the dashboard. The PC dashboard may further indicate whether or not a particular component (or version thereof) is eligible for production deployment based on compliance with the disclosed embodiments. In addition, the PC dashboard may indicate components which are unstable or ineligible based on violations of the policy requirements.

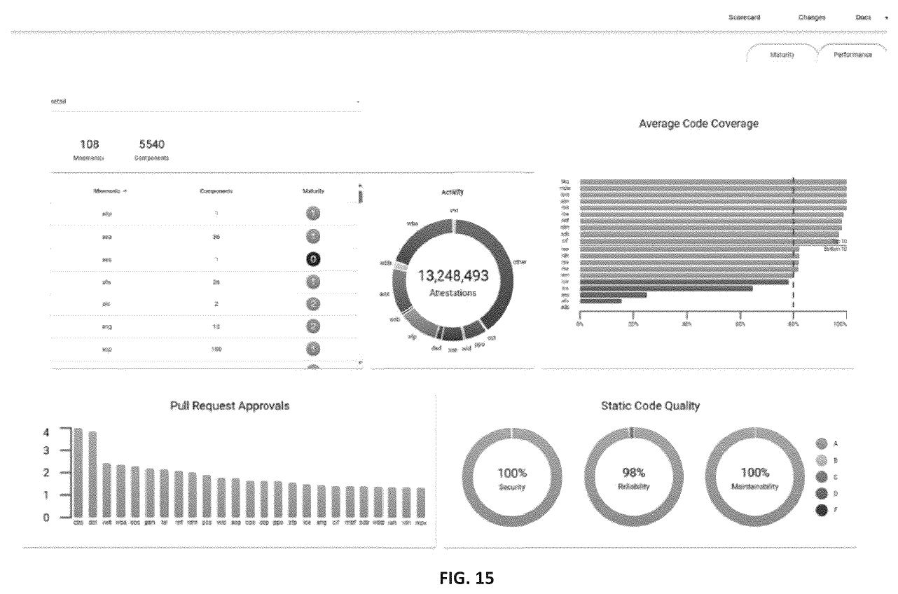

FIG. 15 depicts an exemplary user interface displaying a scorecard associated with a full set of applications and corresponding components, in accordance with disclosed embodiments. The scorecard may enable users (e.g., managers, executives) to better understand the health, maturity, and compliance of their software applications via a high-level visualized analysis. As an example, as illustrated in FIG. 13, the Scorecard may indicate a maturity level associated with each component of an application (e.g., Level 0—Legacy Build, Level 1—Build Compliant, Level 2—Security Compliant, Level 3—Continuous Release). A maturity level may be computed based on PC attestation data and may indicate a component's progress towards full adoption of the disclosed embodiments.

FIG. 16 depicts example system environment 1600 for automated governance system 210, in accordance with disclosed embodiments. System environment 1600 may depict system architecture used to implement any of the systems or methods described herein or depicted in FIGS. 1-15. Users 130 (e.g. developers), may commit an artifact (e.g., code or code change) that triggers activation of CI pipeline 1602, as described previously. An artifact may be a byproduct or output generated during the software development process. Artifacts may include tangible items such as source code, binaries, documentation, design diagrams, configuration files, or test reports. Source control management (SCM) 1604 (or version control) may receive the artifact from users 130 to handle version control, or track changes to the application's software code. SCM 1604 may be the practice of tracking and managing changes to software code. For example, SCM 1604 may enable collaboration among developers, aid in maintaining version history, or help facilitate the coordination of modifications across multiple files or projects. Code quality event 1606 may scan code or artifact for issues, as described previously. CI pipeline 1602 may build events and initiate PC event service 1608, which may be responsible for processing events built through CI pipeline 1602. CI pipeline 1602 may also publish the artifacts in artifact repository 1603 for later access.

Events may be managed by event management engine 1610, which may coordinate with PC event service 1608, PC enforcer service 1612, or PC notary service 1614. Various controls may be implemented in association with event management engine 1610 (e.g., controls 730 in FIG. 7). PC event service 1608 may act to receive information from SCM 1604 or CI pipeline 1602 and provide the event information to event management engine 1610. PC enforcer service 1612 may perform security checks on the artifact using input from various security systems in combination with policy 1613, as established by organization regulation or management (e.g., administrator 110 of FIGS. 1-2). PC notary service 1614 may ensure that records are maintained for attestations (e.g. controls 730 of FIG. 7). Metadata associated with artifacts, attestations, or events may be stored by artifact API 1616.

CD pipeline 1618 may operate with CI pipeline 1602 to enable compliance and deployment of artifacts. For example, artifacts may be promoted to secure deploy 1620 where provenance or gating may occur before sending the attestation to PC gating service 1622. PC gating service 1622 may correlate attestations stored by artifact API 1616 (e.g., from event management engine 1610) to a PAC file to make a decision on whether to promote an artifact. For example, successful validation against all attestations may result in promotion and deployment of the artifact. Such a deployment, using system environment 1600, may provide an automated means of deploying code using PC standard changes in an automated governance system.

Disclosed embodiments may include PC changes, which may enable fully compliant application components to release to production by simply running the corresponding pipelines (e.g., promote and release pipelines). PC changes may occur using system environment 1600 of FIG. 16. As discussed with respect to FIGS. 11-15, eligibility for PC changes may be viewed at the component level via the PC dashboard. In some embodiments, eligibility for PC changes may be indicated by specific indicators, such as, e.g., code change eligible, code change ineligible, code change unreleased, code change unavailable. A code change eligible indicator may symbolize that a component (or a selected version thereof) is eligible for a PC Change, and that no action is required by a user prior to production deployment. A code change ineligible indicator may symbolize that a component (or a selected version thereof) is not eligible for a PC change, and that a user should ensure that the component is compliant with all necessary policy requirements (e.g., that all the policy requirements in the PC dashboard are met). A code change unreleased indicator may symbolize that a component has not yet been released to production, and that a user should execute a successful production release using a pipeline (e.g., the enterprise pipeline). A code change unavailable indicator may symbolize that a component is not able to execute PC changes.

Once an application component (or version thereof) becomes eligible for PC changes, a user may initiate the PC change using any methods discussed herein. Various types of PC changes may be initiated, such as, e.g., PC standard changes, as described previously, PC code changes, or PC image changes. PC code changes may refer to changes to business logic within an application (e.g., new features, bug fixes, refactoring). For a component to become eligible for a PC code change, certain criteria may have to be met. For example, a component may be required to be: (i) cloud native (e.g., be a containerized component deploying to a container architecture such as, e.g., OpenShift™ or Kubernetes™), (ii) previously released to production (e.g., not a first time production deployment), (iii) associated with an approved policy; (iv) associated with code changes that do not require changes to infrastructure, (v) associated with a deploy manifest having new component versions passing all required PC controls (as defined in a PAC file), and (vi) associated with only code changes that do not affect security key controls (e.g., the code change may not create additions or modifications to sensitive or administrative features or functions of the application). PC image changes may refer to changes that update the production base image(s) to ensure that vulnerabilities are addressed promptly. PC changes may follow the following criteria: (i) Change Manifest (e.g., a file maintained in a user's deploy repository and updated with metadata for use by one or more pipelines during execution; and (ii) a manual attestation added to every user story listed in the change manifest (e.g., to verify that no security key controls are affected).

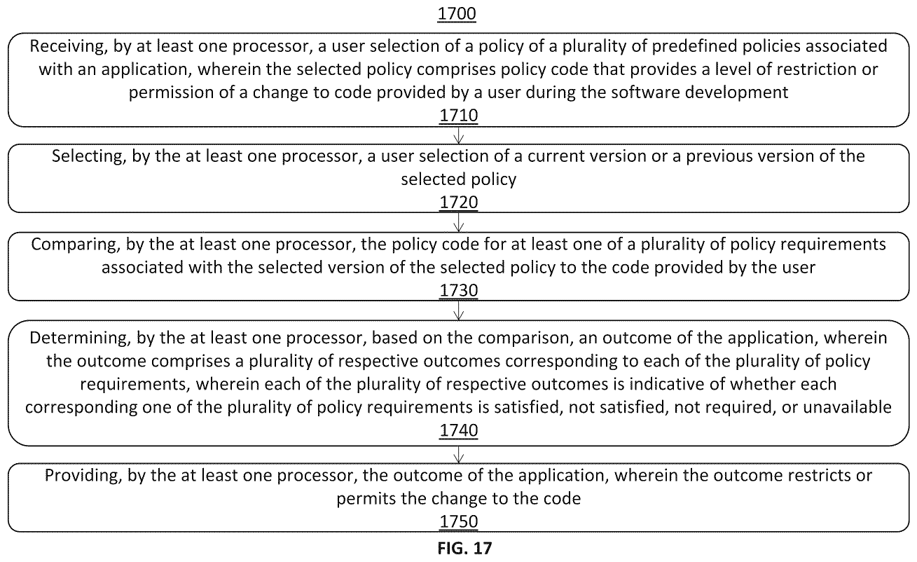

FIG. 17 illustrates example process 1700 for using an automated governance system, in accordance with disclosed embodiments. The automated governance system may be used to provide a scalable means to implement policy as code in the software development lifecycle. Process 1700 may be implemented using any of the embodiments disclosed herein or depicted in FIGS. 1-16.

In step 1710, process 1700 may include receiving, by at least one processor, a user selection of a policy of a plurality of predefined policies associated with an application. The selected policy may include policy code that provides a level of restriction or permission of a change to code provided by a user during the software development. User selection may include a developer selecting which policy to be addressed out of plurality of policies. For example, the developer may view policies on a user interface, as depicted in FIGS. 12-14. Each policy may be associated with a version. For example, as shown in FIGS. 13 and 14, the user may identify a policy that is blocking deployment of code, and select this policy to view.

In step 1720, process 1700 may include selecting, by the at least one processor, a user selection of a current version or a previous version of the selected policy. A developer may select a policy and the automated governance system may provide the developer with the options of viewing the previous and current versions of the policy. For example, a developer may wish to compare a previous version to the current version to determine how to overcome the rejection associated with the current policy.

In step 1730, process 1700 may include comparing, by the at least one processor, the policy code for at least one of a plurality of policy requirements associated with the selected version of the selected policy to the code provided by the user. This comparison may involve checking for various aspects such as security protocols, coding conventions, and regulatory compliance, helping to ensure that the code meets organizational or regulatory expectations before it is approved for further stages of development or deployment. For example, any of the various attestations, policy requirements, tests, or scans described previously may be used to perform this comparison.

In step 1740, process 1700 may include determining, by the at least one processor, based on the comparison, an outcome of the application. The outcome may include a plurality of respective outcomes corresponding to each of the plurality of policy requirements. For example, one policy requirement might relate to security standards, such as ensuring that a user input code is cleaned to prevent SQL injection attacks. In this example, the outcome for this requirement may indicate whether the user code complies with this security measure, resulting in a ‘pass’ if user input is properly cleaned or a ‘fail’ if it does not pass the checks. In another example, a requirement may focus on code quality metrics, such as maintaining a cyclomatic complexity threshold for code maintainability. A cyclomatic complexity threshold may be a predefined limit or value used to evaluate the complexity of a software program based on its control flow. In this example, the outcome may be a complexity score indicating whether the code meets the maximum allowable complexity, along with suggestions if the score exceeds the threshold. In yet another example, if one requirement pertains to the licensing of third-party libraries, the outcome might report on licenses that are incompatible with the project's intended use, stating something such as, “Fail: License for Library X does not comply with project licensing policies.” In yet another example, requirements may focus on adherence to specific coding standards, and outcomes may highlight violations (e.g., “Fail: Variable ‘x’ does not follow the naming convention”). Each of the plurality of respective outcomes may be indicative of whether each corresponding one of the plurality of policy requirements is satisfied, not satisfied, not required, or unavailable. For example, if the outcome is satisfied, the outcome may include a ‘pass’, while if the outcome is not satisfied, the outcome may include a ‘fail’. For example, a policy requirement may be “all database connections must use SSL encryption to protect data in transit,” and system may not assess compliance with the SSL policy due to missing or incomplete configuration parameters, so the outcome may indicate that a requirement is unavailable.

In step 1750, method 1700 may include providing a respective outcome of the application for a plurality of policy requirements associated with the selected policy and the selected version. The respective outcome may be indicative of whether a respective policy requirement is satisfied, not satisfied, not required, or unavailable. Policy requirements may refer to each component of the policy that should be met before providing an outcome determined to be satisfied. For example, as shown in FIG. 13, the policy for the current version is not satisfied, while in FIG. 14, the previous version was satisfied. Allowing the developer to view the outcome and the previous and current version of the policy helps to facilitate more expedient software development. For example, if the developer pushed a code change and the automated governance system detected issues with a PC not meeting the requirements for an attestation associated with a PAC file, then the platform may indicate an issue that needs to be addressed. In this example, the code change will be paused and not promoted to deployment.

In step 1750, process 1700 may include providing, by the at least one processor, the outcome of the application, wherein the outcome restricts or permits the change to the code. The outcome may be displayed to a user. For example, in FIGS. 13-14, the outcome shows that for one policy, a code change was not accepted, while for a previous policy version, the code was accepted. For example, the code change being not accepted may occur if any of various attestations or controls (e.g., controls 730 of FIG. 7) are not passed. For example, the outcome may indicate that all checks associated with attestations have been met and a code change may be deployed immediately or automatically.

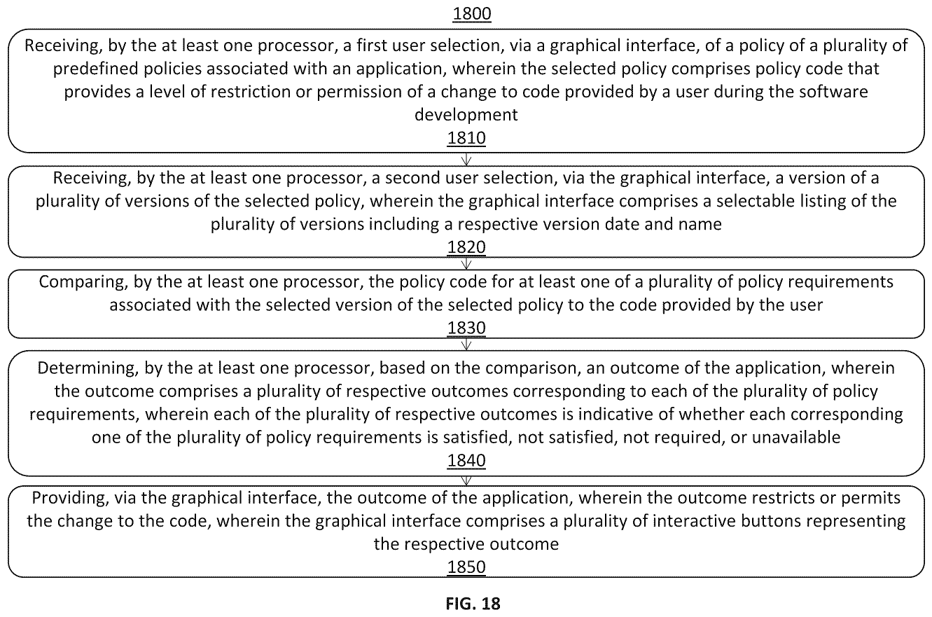

FIG. 18 illustrates example process 1800 for using an automated governance system through a graphical user interface, in accordance with disclosed embodiments. The automated governance system may be used to provide a scalable means to implement policy as code in the software development lifecycle. Process 1800 may be implemented using any of the embodiments disclosed herein or depicted in FIGS. 1-16.

In step 1810, process 1800 may include receiving, by the at least one processor, a first user selection, via a graphical interface, of a policy of a plurality of predefined policies associated with an application. The selected policy may include policy code that provides a level of restriction or permission of a change to code provided by a user during the software development. The predefined policies may be predefined by organizational protocols, regulation, or management.

In step 1820, process 1800 may include receiving, by the at least one processor, a second user selection, via the graphical interface, a version of a plurality of versions of the selected policy. The graphical interface may include a selectable listing of the plurality of versions including a respective version date and name. For example, the graphical interface may include a selectable listing of the plurality of versions including a respective version date and name. The version date and name may be presented in chronological order (or reverse). The order may be sortable by date or name.

In step 1830, process 1800 may include comparing, by the at least one processor, the policy code for at least one of a plurality of policy requirements associated with the selected version of the selected policy to the code provided by the user.

In step 1840, process 1800 may include determining, by the at least one processor, based on the comparison, an outcome of the application. The outcome may include a plurality of respective outcomes corresponding to each of the plurality of policy requirements, wherein each of the plurality of respective outcomes is indicative of whether each corresponding one of the plurality of policy requirements is satisfied, not satisfied, not required, or unavailable.

In step 1850, process 1800 may include providing, via the graphical interface, the outcome of the application. The outcome may restrict or permit the change to the code. The graphical interface may include a plurality of interactive buttons representing the respective outcome. The outcome may be indicative of whether of a respective policy requirement is satisfied, not satisfied, not required, or unavailable. The graphical interface may include a plurality of interactive buttons representing the respective outcome. For example, in FIGS. 13 and 14, each of the policy requirements are represented by selectable buttons which show whether each policy requirement is satisfied or not.

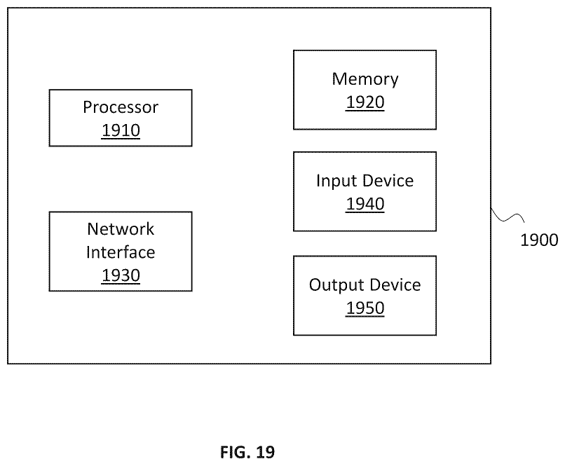

FIG. 19 depicts an example of computing device 1900, in accordance with disclosed embodiments. Various operations as described herein may be performed using computing device 1900. Computing device 1900 may include processor 1910 and memory 1920 storing instructions that, when executed by the at least one processor, may cause the at least one processor to perform one or more operations as described herein. Processor 1910 may include, for example, central processing units (CPUs), graphics processing units (GPUs), digital signal processors (DSPs), field programmable gate arrays (FPGAs), integrated circuits, microcontrollers, microchips, microprocessors, or other units suitable for executing instructions or performing logic operations. Processor 1910 may include a single-core or multiple-core processor (e.g., dual-core, quad-core, or with any desired number of cores). Processor 1910 may provide the ability to execute, run, control, manage, or store multiple processes, applications, or programs. Memory 1920 may include a non-transitory computer-readable medium that may store instructions. Memory 1920 may include, for example, volatile memory, non-volatile memory, flash drives, caches, registers, hard drives, disks, an optical data storage medium, a physical medium with patterns, random access memory (RAM), read-only memory (ROM), programmable read-only memory (PROM), erasable programmable read-only memory (EPROM), compact disc read-only memory (CD-ROM), digital versatile discs (DVDs), non-volatile random-access memory (NVRAM), or networked versions thereof.

Computing device 1900 may further include at least one network interface 1930 (e.g., a network card, a modem, and/or any other device that may be configured to provide data communication via a network), one or more input devices 1940 (e.g., a keyboard, a mouse, a touch screen, a joystick, a touch pad, one or more buttons, a microphone, a sensor, and/or any other device configured to detect and/or receive input), and/or one or more output devices 1950 (e.g., a display (e.g., a light-emitting diode (LED) display, a liquid-crystal display (LCD), an organic light-emitting diode (OLED) display, or a dot-matrix display), a screen, a touch screen, a headphone, a speaker, a light indicator, a light source, a device configured to provide tactile cues, a vibrator, and/or any other device configured to provide output). For example, network interface 1930 may operate via network 120 of FIGS. 1-2.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is to be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications, and variations will be apparent to those skilled in the art. Accordingly, it is intended to embrace all such alternatives, modifications and variations that fall within the spirit and broad scope of the appended claims.

1. A computer implemented method for providing an automated governance platform for software development, the method comprising:
receiving, by at least one processor, a user selection of a policy of a plurality of predefined policies associated with an application, wherein the selected policy comprises policy code that provides a level of restriction or permission of a change to code provided by a user during the software development;
selecting, by the at least one processor, a user selection of a current version or a previous version of the selected policy;
comparing, by the at least one processor, the policy code for at least one of a plurality of policy requirements associated with the selected version of the selected policy to the code provided by the user;
determining, by the at least one processor, based on the comparison, an outcome of the application, wherein the outcome comprises a plurality of respective outcomes corresponding to each of the plurality of policy requirements, wherein each of the plurality of respective outcomes is indicative of whether each corresponding one of the plurality of policy requirements is satisfied, not satisfied, not required, or unavailable; and
providing, by the at least one processor, the outcome of the application, wherein the outcome restricts or permits the change to the code.

2. The computer implemented method of claim 1, wherein providing the outcome further comprises:
detecting an event in the software development of the application;
capturing and digitally signing the event;
storing the event; and
creating a system record of the stored event, wherein the system record further comprises metadata associated with the stored event.

3. The computer implemented method of claim 2, wherein the method further comprises:
transmitting the system record on a code development pipeline; and
creating at least one control attestation based on the metadata.

4. The computer implemented method of claim 1, further comprising:
receiving a policy change to one of the plurality of policy requirements; and
implementing, by the at least one processor, the change to the code or the policy change according to a trunk-based development branching strategy.

5. The computer implemented method of claim 1, wherein the policy of the plurality of predefined policies is a user defined policy.

6. The computer implemented method of claim 1, wherein the plurality of policy requirements are specified in a proxy auto-configuration file (PAC file), wherein the PAC file is adaptable according to the application or the policy.

7. A system for providing an automated governance platform for software development, the system comprising:
at least one processor programmed to:
receive, by at least one processor, a user selection of a policy of a plurality of predefined policies associated with an application, wherein the selected policy comprises policy code that provides a level of restriction or permission of a change to code provided by a user during the software development;
select, by the at least one processor, a user selection of a current version or a previous version of the selected policy;
compare, by the at least one processor, the policy code for at least one of a plurality of policy requirements associated with the selected version of the selected policy to the code provided by the user;
determine, by the at least one processor, based on the comparison, an outcome of the application, wherein the outcome comprises a plurality of respective outcomes corresponding to each of the plurality of policy requirements, wherein each of the plurality of respective outcomes is indicative of whether each corresponding one of the plurality of policy requirements is satisfied, not satisfied, not required, or unavailable; and
provide, by the at least one processor, the outcome of the application, wherein the outcome restricts or permits the change to the code.

8. The system of claim 7, wherein the at least one processor is further programmed to:
detect an event in the software development of the application;
capture and digitally sign the detected event; and
store the digitally signed and detected event thereby creating a system record, wherein the system record further comprises metadata associated with the event.

9. The system of claim 8, wherein the at least one processor is further programmed to:
transmit the system record on a code development pipeline; and
create at least one control attestation based on the metadata.

10. The system of claim 7, wherein the at least one processor is further programmed to:
receive, by the at least one processor, changes to policy code associated with the policy or the application; and
implement, by the at least one processor, changes to the policy code according to a trunk-based development branching strategy.

11. The system of claim 7, wherein the policy of the plurality of predefined policies is a user defined policy.

12. The system of claim 7, wherein the plurality of policy requirements are specified in a proxy auto-configuration file (PAC file), wherein the PAC file is adaptable according to the application or the policy.

13. A non-transitory computer-readable medium storing an automated governance platform for software development, including instructions that, when executed by a processor, causes the automated governance platform to:
receiving, by at least one processor, a user selection of a policy of a plurality of predefined policies associated with an application, wherein the selected policy comprises policy code that provides a level of restriction or permission of a change to code provided by a user during the software development;
select, by the at least one processor, a user selection of a current version or a previous version of the selected policy;
compare, by the at least one processor, the policy code for at least one of a plurality of policy requirements associated with the selected version of the selected policy to the code provided by the user;
determine, by the at least one processor, based on the comparison, an outcome of the application, wherein the outcome comprises a plurality of respective outcomes corresponding to each of the plurality of policy requirements, wherein each of the plurality of respective outcomes is indicative of whether each corresponding one of the plurality of policy requirements is satisfied, not satisfied, not required, or unavailable; and
provide, by the at least one processor, the outcome of the application, wherein the outcome restricts or permits the change to the code.

14. A computer implemented method for providing an automated governance platform for software development, the method comprising:
receiving, by the at least one processor, a first user selection, via a graphical interface, of a policy of a plurality of predefined policies associated with an application, wherein the selected policy comprises policy code that provides a level of restriction or permission of a change to code provided by a user during the software development;
receiving, by the at least one processor, a second user selection, via the graphical interface, a version of a plurality of versions of the selected policy, wherein the graphical interface comprises a selectable listing of the plurality of versions including a respective version date and name;
comparing, by the at least one processor, the policy code for at least one of a plurality of policy requirements associated with the selected version of the selected policy to the code provided by the user;
determining, by the at least one processor, based on the comparison, an outcome of the application, wherein the outcome comprises a plurality of respective outcomes corresponding to each of the plurality of policy requirements, wherein each of the plurality of respective outcomes is indicative of whether each corresponding one of the plurality of policy requirements is satisfied, not satisfied, not required, or unavailable; and
providing, via the graphical interface, the outcome of the application, wherein the outcome restricts or permits the change to the code, wherein the graphical interface comprises a plurality of interactive buttons representing the respective outcome.

15. The computer implemented method of claim 14, wherein the providing the respective outcome further comprises:
detecting an event in the software development of the application;
capturing and digitally signing the detected event; and
storing the digitally signed and detected event thereby creating a system record, wherein the system record further comprises metadata associated with the event.

16. The computer implemented method of claim 15, wherein the method further comprises:
transmitting the system record on a code development pipeline;
creating at least one control attestation based on the metadata; and
displaying, via the graphical interface, a result of the at least one attestation, wherein the graphical interface comprises an interactive button representing the result.

17. The computer implemented method of claim 14, further comprising:
receiving, by the at least one processor, changes to policy code associated with the policy or the application; and
implementing, by the at least one processor, changes to the policy code according to a trunk-based development branching strategy.

18. The computer implemented method of claim 14, wherein at least one policy of the plurality of predefined policies is an adaptable user defined policy, the method further comprising:
upon a third user selection of an interactive button on the graphical interface, displaying a window of the graphical interface and receiving a user provided modification to the at least one policy via the window.

19. The computer implemented method of claim 14, wherein the plurality of policy requirements are specified in a PAC file, wherein the PAC file is adaptable according to the application or the policy.

20. A non-transitory computer-readable medium storing an automated governance platform for software development including instructions that, when executed by a processor, causes the automated governance platform to:
receive, by the at least one processor, a first user selection, via a graphical interface, of a policy of a plurality of predefined policies associated with an application, wherein the selected policy comprises policy code that provides a level of restriction or permission of a change to code provided by a user during the software development;
receive, by the at least one processor, a second user selection, via the graphical interface, a version of a plurality of versions of the selected policy, wherein the graphical interface comprises a selectable listing of the plurality of versions including a respective version date and name;
compare, by the at least one processor, the policy code for at least one of a plurality of policy requirements associated with the selected version of the selected policy to the code provided by the user;
determine, by the at least one processor, based on the comparison, an outcome of the application, wherein the outcome comprises a plurality of respective outcomes corresponding to each of the plurality of policy requirements, wherein each of the plurality of respective outcomes is indicative of whether each corresponding one of the plurality of policy requirements is satisfied, not satisfied, not required, or unavailable; and
provide, via the graphical interface, the outcome of the application, wherein the outcome restricts or permits the change to the code, wherein the graphical interface comprises a plurality of interactive buttons representing the respective outcome.
